(19) United States
(12) Patent Application Publication
(10) Pub. No.: US 2012/0020608 A1
(43) Pub. Date: Jan. 26, 2012

(54) Plasmonic Element With Waveguide Trapping

(76) Inventors: Gary Gibson, Palo Alto, CA (US); Richard H. Henze, San Carlos, CA (US)

(21) Appl. No.: 13/260,262

(22) PCT Filed: Feb. 11, 2010
(86) PCT No.: PCT/US2010/023806

§ 371 Date: Sep. 24, 2011

(51) Int. Cl. G02F 1/035

(52) U.S. Cl. 385/1

(57) ABSTRACT

Various plasmonic elements with waveguide trapping are provided. In one embodiment, a plasmonic element includes a waveguide layer including a first surface through which incident light enters the waveguide layer. The waveguide layer includes a medium and an array of plasmonic structures disposed within the medium. The medium has dielectric properties. The resonant frequency of the plasmonic structures is responsive to the dielectric properties of the medium. The plasmonic element is configured to trap incident light scattered by the plasmonic structures in a waveguide mode.

### BACKGROUND

A reflective display is a non-emissive device in which ambient light is used for viewing the displayed information. Rather than modulating light from an internal source, desired portions of the incident light spectrum are reflected from the display back to a viewer. Electronic paper (e-paper) technologies have evolved to provide single layer monochromatic displays that control the reflection of ambient light.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIGS. 1 and 2 are graphical representations of plasmonic elements with waveguide trapping in accordance with embodiments of the present disclosure,

FIG. 3 is a graphical representation of a pixel with side-by-side sub-pixels including plasmonic elements of FIGS. 1 and 2 in accordance with one embodiment of the present disclosure.

FIG. 4 is a graphical representation of a color filter including a plasmonic element of FIGS. 1 and 2 in accordance with one embodiment of the present disclosure.

### DETAILED DESCRIPTION

Disclosed herein are various embodiments related to plasmonic elements with waveguide trapping. Reference will now be made in detail to the description of the embodiments as illustrated in the drawings, wherein like reference numbers indicate like parts throughout the several views.

It is desirable for paper-like displays to provide a bright, full color gamut. A color gamut can be produced by combining primary colors, for example with additive (e.g., red-green-blue) side-by-side sub-pixels or with subtractive (e.g., cyan-magenta-yellow) vertically stacked cells. However, an architecture that employs three side-by-side fixed-color sub-pixels reflects only about one third of the incident light of a given color. Additionally, stacked architectures tend to be complicated, suffer from stray reflections and absorption losses in their numerous layers, and exhibit limited aperture ratios and parallax.

Alternatively, a material that reflects light in a wavelength band that can be tuned throughout the visible spectrum would enable a wide color gamut using relatively simple device geometries. A weighted combination of two spectrally pure colors can be used to create any color within the gamut perceived by humans. For much of the color gamut, two color-tunable sub-pixels, either side-by-side or stacked, may be used to produce the desired color with improved brightness.

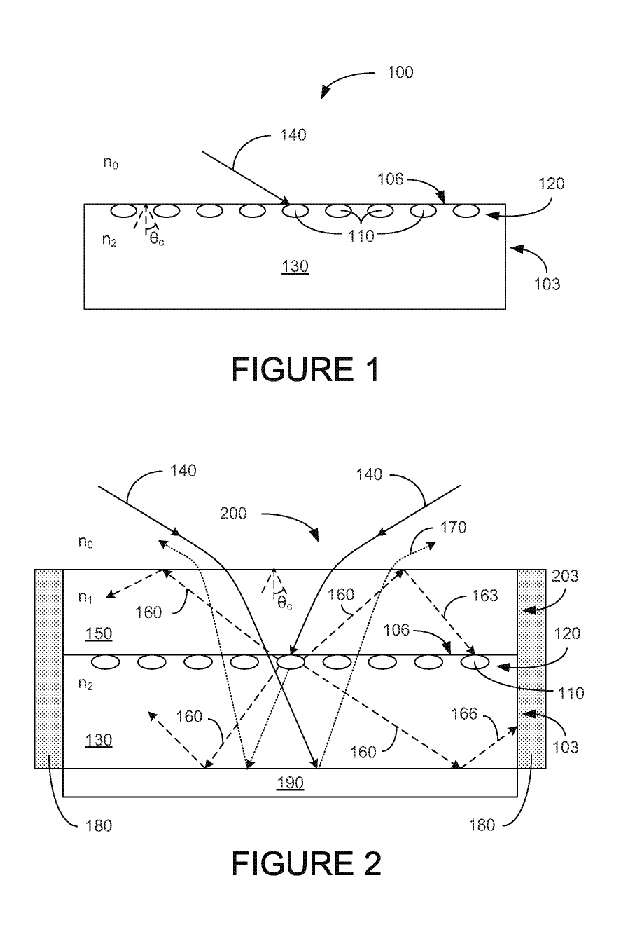

FIG. 1 is a graphical representation of an element 100 such as, but not limited to, a sub-pixel in accordance with one embodiment of the present disclosure. Element 100 may be a color-tunable or fixed-color element. In the embodiment of FIG, 1, a waveguide layer 103 includes plasmonic structures (or particles) 110 arranged in a two-dimensional (2D) array 120 within a dielectric environment. The waveguide layer 103 also includes a first surface 106 through which incident ambient light 140 enters the waveguide layer 103.

Plasmonic structures 110 include metallic or composite metallic-dielectric particles that support localized plasmon resonances. The plasmonic structures 110 are configured to absorb a portion of incident light 140 when excited near a resonant frequency of the plasmonic structures 110. Localized plasmon resonances are collective oscillations of conduction electrons that can couple strongly to light. Noble metals such as silver (Ag) and gold (Au) typically provide strong plasmon resonances. Examples of suitable plasmonic structures 110 include solid or hollow nanometer-scale spheres of a metal such as gold, silver, aluminum, platinum, or alloys of such metals, solid or hollow metal particles having non-spherical shapes, composite particles made of both metal and dielectric materials, and layered structures containing multiple metal and/or dielectric materials such as layered concentric spherical shells or cylinders or layered films.

Tuning the color of a plasmonic structure 110 is possible because the plasmon resonant frequency of such structures generally depends on the dielectric properties of the environment surrounding the structure and on inter-particle interactions within the array. In the exemplary embodiment of FIG. 1, the waveguide layer 103 includes a medium 130, which has dielectric properties that can be changed through the application of an external stimulus, that surrounds the plasmonic structures 110 of the 20 array 120. The resonant frequency of the plasmonic structures 110 is responsive to the dielectric properties of the medium 130. Thus, the optical absorption and/or scattering spectra (and therefore the color) of the plasmonic structures 110 can be varied by altering the dielectric properties of the surrounding medium 130.

In one exemplary embodiment, the medium 130 is a non-absorbing or weakly absorbing liquid crystal; however the medium 130 could alternatively be a different electro-optic material having a refractive index that depends on an applied electric field or a material with dielectric properties that depend on other external stimuli. Electrodes can be positioned on opposite sides of the medium 130 to apply the electric field. The voltage difference across the medium can be used to vary the refractive indices of the medium 130, which varies the frequency of the plasmon resonances and thereby varies the optical spectra for scattering and/or absorption by the plasmonic structures 110. Other material types may also be used to change the dielectric properties surrounding the plasmonic structures 110. For example, the dielectric properties of the medium 130 surrounding the structures 110 can be changed by introducing or removing solutions with different refractive indices.

In one embodiment, among others, a liquid with a given refractive index can be reversibly swept over the plasmonic structures 110, for example, via electro-wetting. In another embodiment, a reversible flow of liquid can be driven mechanically, e.g., with capacitively-actuated diaphragms or piezoelectrics or thermally (e.g., by vaporizing liquid or expanding gas) to alter the medium 130. Alternatively, high index particles may be electrophoretically moved in the fluid to change the refractive index of the medium 130 surrounding the array 120. In other embodiments, tuning can be accomplished by altering the inter-particle interaction by changing the spacing between particles 110 in the array 120.

The scattering cross-section for sub-wavelength, isolated spherical metal particles (e.g., as described by Mie scattering theory) increases in proportion to the 6th power of their radius (r⁶), whereas their absorption cross-section depends on the 3rd power of their radius (r³). Accordingly, very small isolated particles (e.g., ≦30 nm for Au or Ag) will primarily absorb light, whereas somewhat larger isolated particles (e.g., ≧60 nm for Ag or Ag) will primarily scatter light. Individual plasmonic particles (or structures) 110 can have scattering and/or absorption cross-sections at the peaks of their plasmonic resonances that are an order of magnitude larger than their physical cross-section. In this case, if there were no interactions between these particles, an array 120 with a fractional coverage area of about 1/10 would either absorb or scatter most of the incident light at resonance, depending upon the size of the particles. However, due to inter-particle interactions, an array of plasmonic particles does not purely absorb or scatter light within a given band, but rather exhibits a combination of absorption and scattering. For example, dense arrays of metal spheres can exhibit hybrid and higher order resonance modes that result in a mixture of optical scattering and absorption. If the array also scatters some of the light within an optical band that should be absorbed, a portion of this light is returned to the viewer compromising the reflective contrast and color saturation.

The array 120 may be located adjacent to the first surface 106 of the waveguide layer 103. The layout of the array 120 can include hexagonal, square, or other appropriate geometries. In other embodiments, the array 120 may be located at a different location within the medium 130. For example, the array 120 may be located at a predefined distance from the first surface 106 (e.g., within a wavelength of the plasmonic resonance) or centered within of the waveguide layer 103. Placement of the array 120 may be affected by the index of refraction of the medium 130 surrounding the array 120.

While FIG. 1 depicts a two-dimensional array of plasmonic structures 110, other embodiments of the present disclosure can include a three-dimensional array of plasmonic structures 110. Examples can include, but are not limited to, a uniform dispersion of metallic or composite metallic-dielectric particles that support localized plasmon resonances and a three-dimensional matrix of particles 110 contained in a polymer, aerogel, or other porous solid matrix.

FIG. 2 is a graphical representation of an element 200 in accordance with another embodiment of the present disclosure. Element 200 may be a color-tunable or fixed-color element. As illustrated in FIG. 2, element 200 includes waveguide layer 103, which includes the array 120 of plasmonic structures 110 disposed within medium 130. In the exemplary embodiment of FIG. 2, element 200 includes a second waveguide layer 203, which includes a substrate 150 disposed adjacent to the first surface 106 of first waveguide layer 103. In the embodiment of FIG. 2, array 120 is located adjacent to the first surface 106 and substrate 150. In some embodiments, a surface of substrate 150 is the first surface 106 of waveguide layer 103. In one embodiment, the array 120 of plasmonic structures 110 is placed (or disposed) on the surface of the substrate 150. In other embodiments, the array 120 may be located at a predefined distance from the substrate 150 (e.g., within a wavelength of the plasmonic resonance). Placement of the array 120 may be affected by the indices of refraction of the substrate 150 and/or the medium 130 surrounding the array 120.

In the exemplary embodiment of FIG. 1, the medium 130 has a high index of refraction, n₂, relative to the viewing environment (e.g., air with index n₀=1) from which incident light 140 is received. In some embodiments, the medium 130 has a refractive index (n₂) in the range of about 1.5 to about 3. In the exemplary embodiment of FIG. 2, the substrate 150 has a high index of refraction, n₁, relative to the viewing environment (e.g., air with index n₀=1) from which incident light 140 is received. In some embodiments, the substrate 150 has a refractive index (n₁) in the range of about 1.5 to about 3. For example, n₁ is approximately 1.9 for indium tin oxide. The medium 130, below substrate 150 and surrounding the array 120, also may have an index of refraction (n₂) that is greater than that of air.

Plasmonic elements 100 and 200 are configured to trap incident light 140 scattered by plasmonic structures 110 in a waveguide mode. FIG. 2 illustrates the interaction of incident light 140 with the first waveguide layer 103 including the plasmonic array 120 and medium 130 and/or the second waveguide layer 203 including substrate 150. Because the index of refraction of the medium 130 and/or the substrate 150 is larger than refractive index (n₀) of the region from which the ambient light 140 comes, some of the light scattered by the plasmonic array 120 is totally internally reflected (TIR) and trapped in waveguide modes within the high index waveguide layers 103 and/or 203.

In an exemplary embodiment, it may be desirable for the plasmonic array 120 to remove a portion of the spectrum of the incident ambient light 140 from the light reflected by elements 100 and/or 200. The removed portion of the spectrum may be tunable or fixed. The plasmonic particle 110 absorbs a portion of the incident light spectrum in the selected band, but also scatters some of the incident light 140 in this same band. Because the indices of refraction of the substrate 150 and/or the medium 130 are larger than that of the region from which the ambient light 140 comes (i.e., the viewer environment), some of the light 160 scattered by the plasmonic particles is totally internally reflected and trapped within the high index waveguide layers 103 and/or 203. Medium 130 and/or substrate 150 may be configured to trap incident light scattered by the plasmonic structures 110. For example, this trapped light 160 can be prevented from reaching the viewer in three ways.

First, high index layers 103 and/or 203 which contain the waveguide modes, e.g., medium 130 and/or substrate 150, can be designed such that they absorb light 160 that is trapped in the waveguide modes, but do not significantly absorb light at wavelengths that are not scattered and trapped. For example, the substrate 150 (and/or the medium 130) may be doped with dye molecules such that the characteristic absorption length is many times the layer thickness. Thus, the substrate 150 and/or the medium 130 may be configured to absorb light at specified wavelengths within the waveguide modes. Light 160 scattered into waveguide modes will travel many layer thicknesses in the substrate 150 (and/or the medium 130) and be absorbed, whereas light 170 at other wavelengths will not be scattered and will be directly reflected out of the element 200 (or 100) with a path length in the absorptive region of only about two layer thicknesses. Thus, dopants used for this purpose can include broadband absorbers as they will only significantly absorb the scattered wavelengths 160.

Second, the scattered light 160 may be eliminated by further absorption by other plasmonic structures 110 of the 2D array 120. In some cases, light that is scattered within waveguide layers 103 and/or 203 is reflected back toward the array 120, where it may be absorbed by a plasmonic particle 110, as illustrated by ray 163. Scattering incident light into waveguide modes causes the scattered wavelengths to interact with plasmonic structures 110 many more times than non-scattered light, thereby increasing the opportunity for absorption of the scattered wavelengths. Third, absorbing waveguide edges 180 (e.g., black for broadband absorption) may be included to enhance absorption of the light 160 coupled into waveguide modes within waveguide layers 103 and/or 203, as illustrated by ray 166.

In some embodiments, the medium 130 and/or the substrate 150 may include multiple physical layers, each having an index of refraction (nₓ), which may provide for a plurality of waveguide layers surrounding the plasmonic array 120. The plasmonic array may be located within one or more of the physical layers. Exactly which waveguide layers trap the scattered light 160 depends on their indices of refraction and the scattering pattern of the plasmonic array 120 (which, itself, depends upon the refractive indices of the neighboring layers, in addition to the size, shape, and periodicity of the plasmonic structures 110 in the array). The index of refraction for a physical layer may be the same or different from that of an adjacent physical layer. Thus, the refractive indices may be chosen in accord with the design of the plasmonic array 120 to improve the overall extinction of the desired (tunable or fixed) optical band via a combination of absorption by the array 120 and trapping scattered light in waveguide modes within layers 103 and/or 203, where the light is subsequently absorbed.

The fraction of scattered light retained in a waveguide mode will depend on the indices of refraction of the relevant layers of the device and the angular scattering pattern of the plasmonic particles 110. In some embodiments, the scattering pattern may be controlled by variations in the size, shape, and/or spacing of the structures within the array 120. Light approaching an interface to a region with a lower index of refraction will be totally internally reflected if its angle of incidence is more than the critical angle, θ_{c}=arcsin(n_{high}/n_{low}), where n_{high} is the higher index and n_{low} is the lower index. As an example, 1−(¼n²) of an isotropically-incident distribution of light will be totally internally reflected at the boundary between a layer with an index of n and a layer with an index of 1.

A diffusive mirror 190 may also be included in elements 100 and/or 200 to improve a reflective display by reducing the specular reflection of the returned light. Incident light that is scattered to angles greater than the critical angle (θ_{c}) will be coupled into waveguide modes within waveguide layers 103 and/or 203. However, measurements on simple device structures indicate that using a diffusive mirror 190 that scatters the incident light over a small angle (e.g., about 10 degrees and/or less than 10 degrees) can improve the viewing experience without significantly increasing the amount of incident light, at wavelengths not scattered by the array 120, that is coupled into waveguide modes.

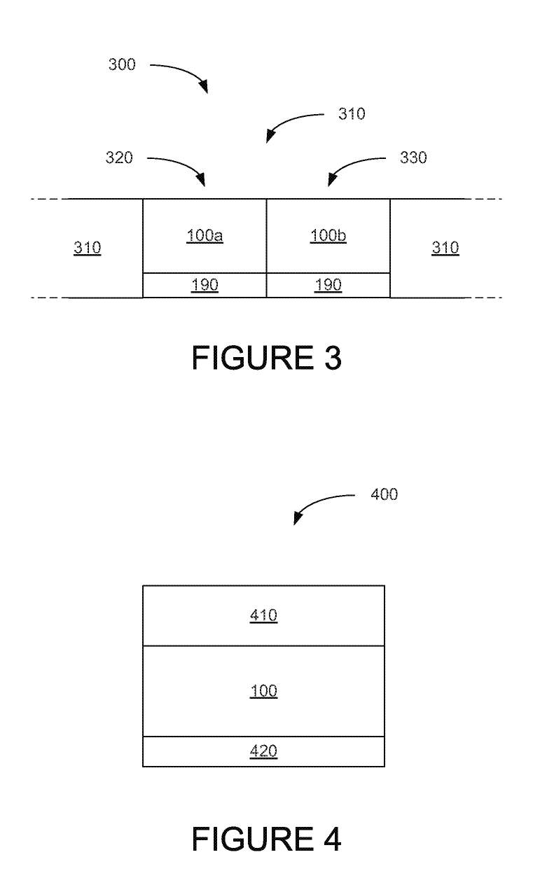

Reflective displays (e.g., e-paper technology) can include arrays of color-tunable plasmonic elements 100 that control the return of light back to a viewer. In some embodiments, a plurality of color-tunable plasmonic sub-pixels are used to provide a wide color gamut. The color of the pixel is controlled by variation of the resonant frequencies of the plasmonic sub-pixels. FIG. 3 is a graphical representation of a display 300 including a plurality of pixels 310. A pixel 310 includes two (or more) side-by-side sub-pixels 320 and 330 including plasmonic elements in accordance with one embodiment of the present disclosure. In the exemplary embodiment of FIG. 3, sub-pixels 320 and 330 include plasmonic elements 100a and 100b, respectively, of FIG. 1 and diffusive mirrors 190. Alternatively, sub-pixels 320 and 330 may include plasmonic elements 200 of FIG. 2. In some embodiments, sub-pixels 320 and 330 may also include absorbing waveguide edges 180 (FIG. 2). The waveguide edges 180 are configured to absorb the light trapped in the waveguide mode.

Alternatively, the principals described in this disclosure can be used to create color filters. Arrays of plasmonic elements 100 and/or 200 can be utilized to filter one or more portions of the light spectrum. FIG. 4 is a graphical representation of a color filter 400 including a plasmonic element in accordance with one embodiment of the present disclosure. In the embodiment of FIG. 4, the color filter 400 includes a shutter 410 configured to adjust light transmission such as, but not limited to, an electro-optic shutter, a mirror 420 such as, but not limited to, a diffusive mirror, and a plasmonic element 100. Alternatively, color filter 400 may include plasmonic element 200 of FIG. 2. In some embodiments, the shutter 410 may be a transparent-white or transparent-black shutter. If a fixed-color filter is desired, then the medium 130 (FIGS. 1 and 2) can be provided with a fixed refractive index to produce the desired filtering. Other color filter embodiments include a passive filter where shutter 410 is omitted from the color filter 400 of FIG. 4. Alternatively, transmissive filters include a plasmonic element with both the shutter 410 and the mirror 420 omitted.

Therefore, at least the following is claimed:

1. A plasmonic element, comprising:
a waveguide layer including a first surface through which incident light enters the waveguide layer, the waveguide layer including:
a medium having dielectric properties; and
an array of plasmonic structures disposed within the medium, the plasmonic structures configured to absorb a portion of a spectrum of the incident light by exciting a resonant frequency of the plasmonic structures, the resonant frequency of the plasmonic structures responsive to the dielectric properties of the medium;
where the plasmonic element is configured to trap incident light scattered by the plasmonic structures in a waveguide mode.

2. The plasmonic element of claim 1, wherein the array of plasmonic structures is disposed adjacent to the first surface of the waveguide layer.

3. The plasmonic element of claim 1, wherein the dielectric properties of the medium can be varied in response to an external stimulus.

4. The plasmonic element of claim 1, wherein the array of plasmonic structures is a two-dimensional array of plasmonic structures.

5. The plasmonic element of claim 1, wherein the medium is configured to absorb the light trapped in the waveguide mode.

6. The plasmonic element of claim 1, further comprising a second waveguide layer including a substrate disposed adjacent to the first waveguide layer, the plasmonic element configured to trap incident light scattered by the plasmonic structures in a waveguide mode within at least one of the first and second waveguide layers.

7. The plasmonic element of claim 6, wherein at least one of the substrate and the medium is configured to absorb the light trapped in the waveguide mode.

8. The plasmonic element of claim 7, wherein the at least one of the substrate and the medium is doped with dye molecules that absorb light at specified wavelengths within the waveguide modes.

9. The plasmonic element of claim 6, wherein the substrate comprises a plurality of physical layers.

10. The plasmonic element of claim 6, wherein the first surface of the first waveguide layer is a surface of the substrate and the array of plasmonic structures is disposed on the surface of the substrate.

11. The plasmonic element of claim 1, further comprising absorbing waveguide edges configured to absorb the light trapped in the waveguide mode.

12. The plasmonic element of claim 1, further comprising a diffusive micro

13. A color filter comprising:
a plasmonic element comprising:
a waveguide layer including a first surface through which incident light enters the waveguide layer, the waveguide layer including:
a medium having dielectric properties; and
an array of plasmonic structures disposed within the medium, the plasmonic structures configured to absorb a portion of a spectrum of the incident light by exciting a resonant frequency of the plasmonic structures, the resonant frequency of the plasmonic structures responsive to the dielectric properties of the medium;
where the plasmonic element is configured to trap incident light scattered by the plasmonic structures in a waveguide mode.

14. A reflective display comprising:
a plurality of pixels, each pixel comprising first and second color-tunable plasmonic sub-pixels, each plasmonic sub-pixel comprising:
a waveguide layer including a first surface through which incident light enters the waveguide layer, the waveguide layer including:
a medium having dielectric properties that can be varied in response to an external stimulus; and
a two-dimensional array of plasmonic structures disposed within the medium, the plasmonic structures configured to absorb a portion of a spectrum of the incident light by exciting a resonant frequency of the plasmonic structures, the resonant frequency of the plasmonic structures responsive to the dielectric properties of the medium;
where each plasmonic sub-pixel is configured to trap incident light scattered by the plasmonic structures in a waveguide mode; and
where the color of the pixel is controlled by variation of the resonant frequencies of the first and second plasmonic sub-pixels.

15. The reflective display of claim 14, wherein the medium is configured to absorb the light trapped in the waveguide mode.

16. The reflective display of claim 14, wherein each plasmonic sub-pixel further comprises a second waveguide layer including a substrate disposed adjacent to the first waveguide layer, the plasmonic sub-pixel configured to trap incident light scattered by the plasmonic structures in a waveguide mode within at least one of the first and second waveguide layers.

17. The reflective display of claim 16, wherein at least one of the substrate and the medium is configured to absorb the light trapped in the waveguide mode.
